(19) United States
(12) Patent Application Publication
(10) Pub. No.: US 2010/0150343 A1
(43) Pub. Date: Jun. 17, 2010

(54) SYSTEM AND METHOD FOR ENCRYPTING DATA BASED ON CYCLIC GROUPS

(75) Inventor: Peter M.F. Rombouts, Hoogstraten (BE)

Correspondence Address: NXP, B.V.;NXP INTELLECTUAL PROPERTY & LICENSING, M/S41-SJ, 1109 MCKAY DRIVE, SAN JOSE, CA, 95131, US

(73) Assignee: NXP B.V., Eindhoven (NL)

(21) Appl. No.: 12/334,847

(22) Filed: Dec. 15, 2008

(51) Int. Cl. H04L 9/06

(52) U.S. Cl. 380/44

(57) ABSTRACT

A technique for performing data encryption for a cryptographic system that utilizes a cyclic group having an order is disclosed. The technique involves encoding a secret key into an encoded secret key using an encoding key, where the secret key and the product of the encoding key and the encoded secret key are congruent modulo the order of the cyclic group, serially encrypting a message into an encrypted message using the encoded secret key and the encoding key, and transmitting the encrypted message to a destination.

Embodiments of the invention relate generally to cryptographic systems and, more particularly, to a system and method for encrypting data based on cyclic groups.

Cryptographic systems perform cryptographic operations such as key encoding and message encrypting to generate encrypted messages and to hide secret values. A concern with cryptographic systems is that side channel analysis (SCA) may be used to obtain information about the secret values by measuring and analyzing physical properties of the cryptographic systems while the cryptographic systems are performing cryptographic operations. For example, power analysis and electromagnetic radiation analysis may be used to obtain information about the secret values by measuring and analyzing the power consumption and the emission of the electromagnetic radiation of the cryptographic systems.

A technique for performing data encryption for a cryptographic system that utilizes a cyclic group having an order is disclosed. The technique involves encoding a secret key into an encoded secret key using an encoding key, where the secret key and the product of the encoding key and the encoded secret key are congruent modulo the order of the cyclic group, serially encrypting a message into an encrypted message using the encoded secret key and the encoding key, and transmitting the encrypted message to a destination.

In an embodiment, a method of performing data encryption for a cryptographic system that utilizes a cyclic group having an order involves encoding a secret key into an encoded secret key using an encoding key, wherein the secret key and the product of the encoded secret key and the encoding key are congruent modulo the order of the cyclic group, serially encrypting a message into an encrypted message using the encoded secret key and the encoding key, and transmitting the encrypted message to a destination.

In an embodiment, another method of performing data encryption for a cryptographic system that utilizes a cyclic group having an order involves encoding a secret key into an encoded secret key, wherein encoding the secret key includes obtaining a first integer, wherein the first integer and the order of the cyclic group are relatively prime, obtaining a second integer, wherein one and the product of the second integer and the first integer are congruent modulo the order of the cyclic group, obtaining the encoded secret key, wherein the encoded secret key and the product of the second integer and the secret key are congruent modulo the order of the cyclic group, and obtaining an encoding key, wherein the encoding key and the first integer are congruent modulo the order of the cyclic group, serially encrypting a message into an encrypted message using the encoded secret key and the encoding key, and transmitting the encrypted message to a destination.

In an embodiment, a system for performing data encryption that utilizes a cyclic group having an order includes a secret key generator, a secret key encoder, a message generator, a message encryptor, and a communication device. The secret key generator is configured to generate a secret key. The secret key encoder is configured to encode the secret key into an encoded secret key using an encoding key, wherein the secret key and the product of the encoded secret key and the encoding key are congruent modulo the order of the cyclic group. The message generator is configured to generate a message. The message encryptor is configured to serially encrypt the message from the message generator into an encrypted message using the encoded secret key and the encoding key. The communication device is configured to transmit the encrypted message to a destination.

Other aspects and advantages of embodiments of the present invention will become apparent from the following detailed description, taken in conjunction with the accompanying drawings, illustrated by way of example of the principles of the invention.

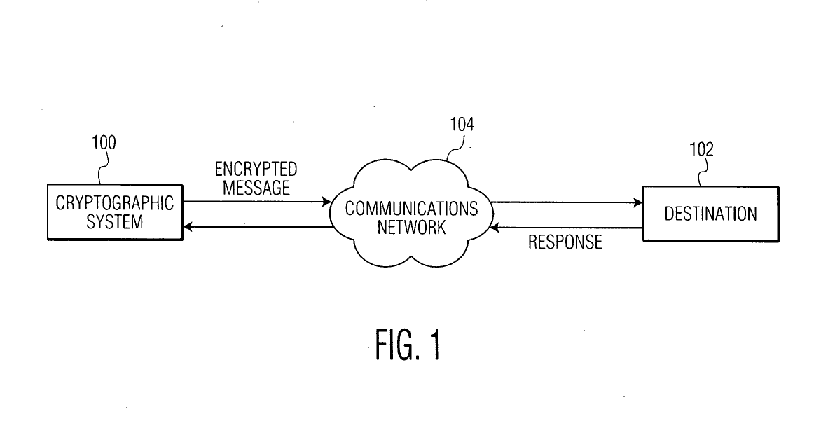

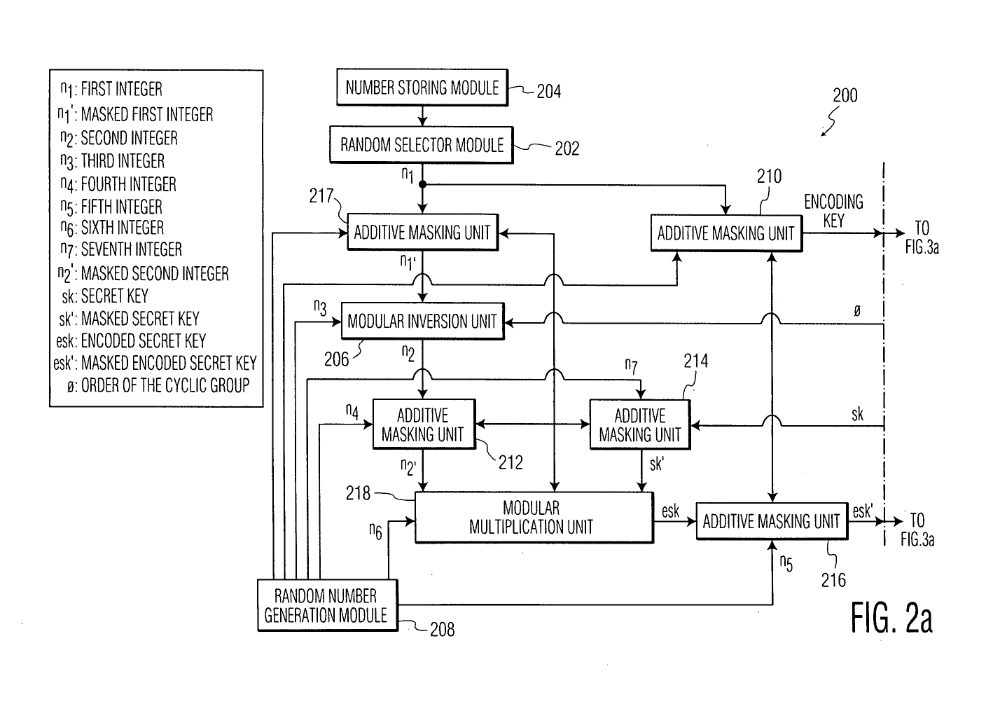

FIG. 1 illustrates communications between a cryptographic system and a destination via a communications network.

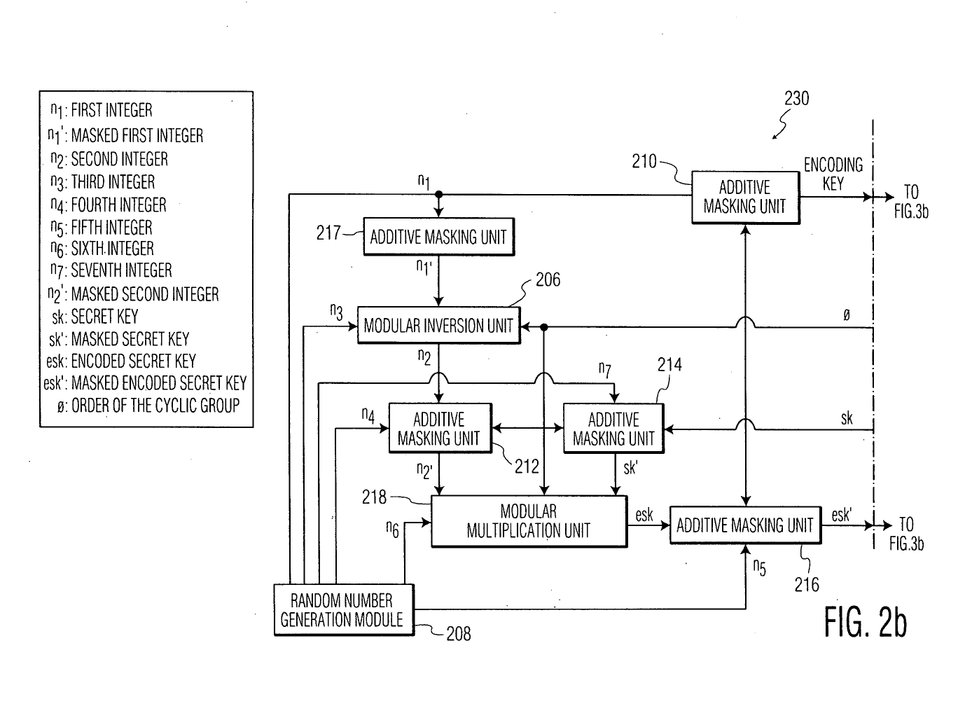

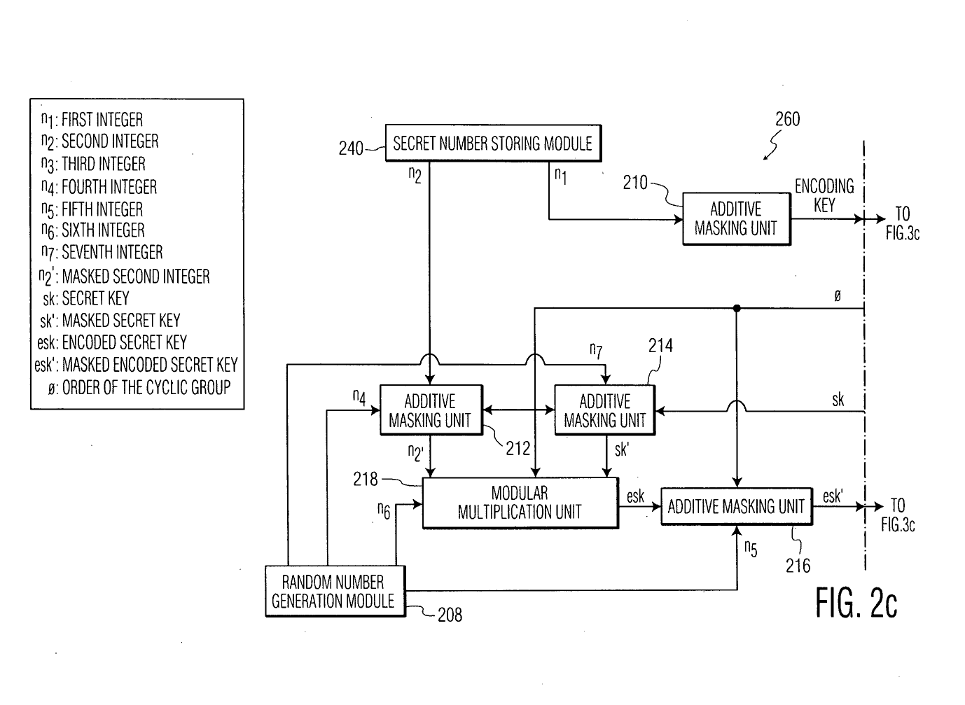

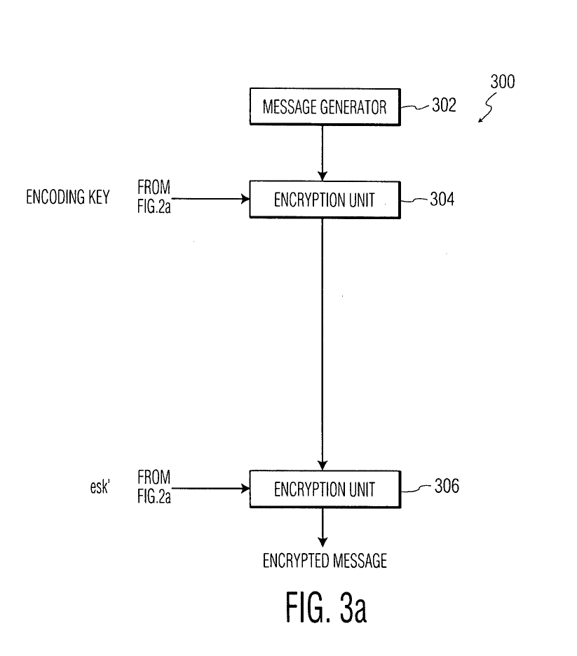

FIGS. 2a-2c depict three embodiments of a system for encoding a secret key.

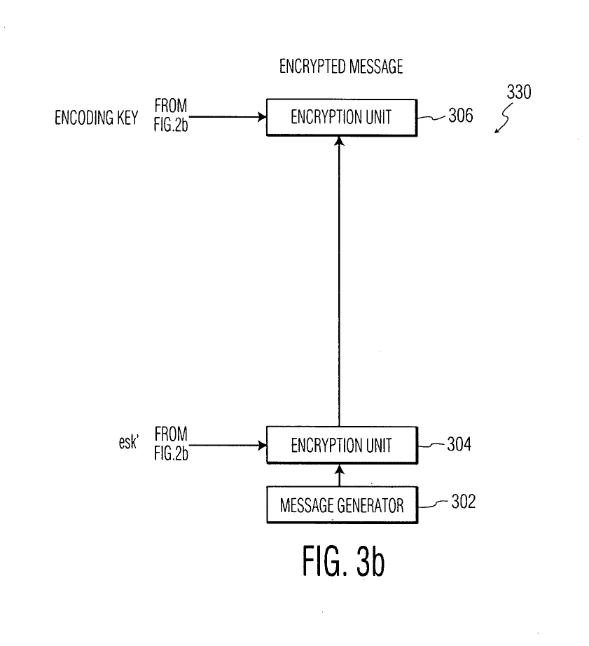

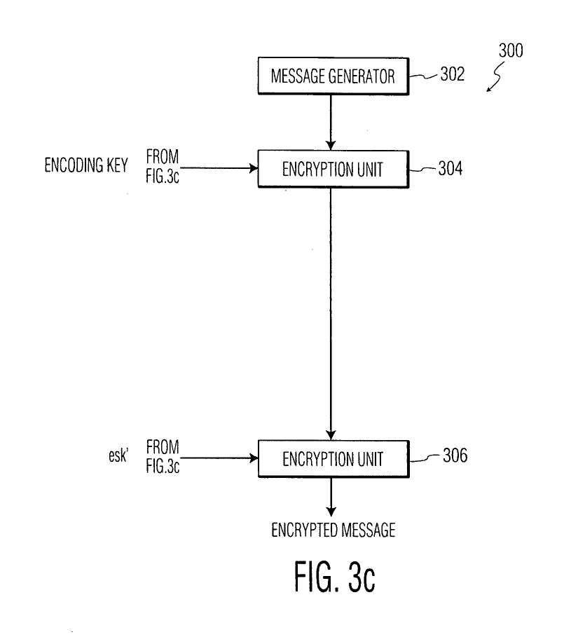

FIGS. 3a-3b depict two embodiments of a system for encrypting a message using an encoded secret key and an encoding key.

FIG. 4 illustrates an embodiment of a system for repeatedly encrypting a message using an encoded secret key and one or more encoding keys that are generated using the systems for encoding a secret key that are depicted in FIGS. 2a-2c.

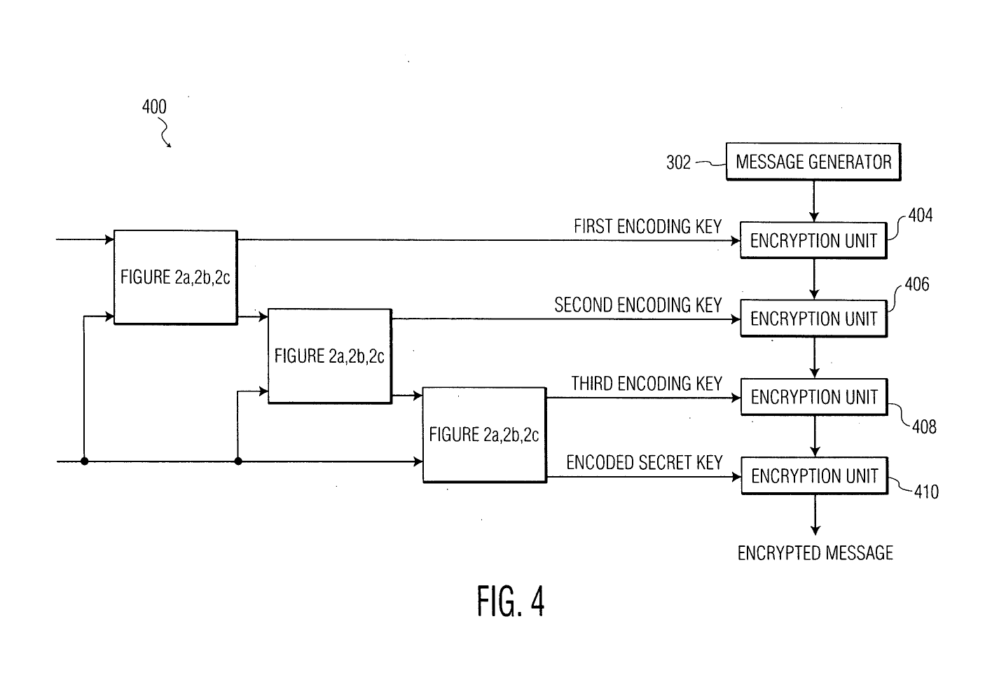

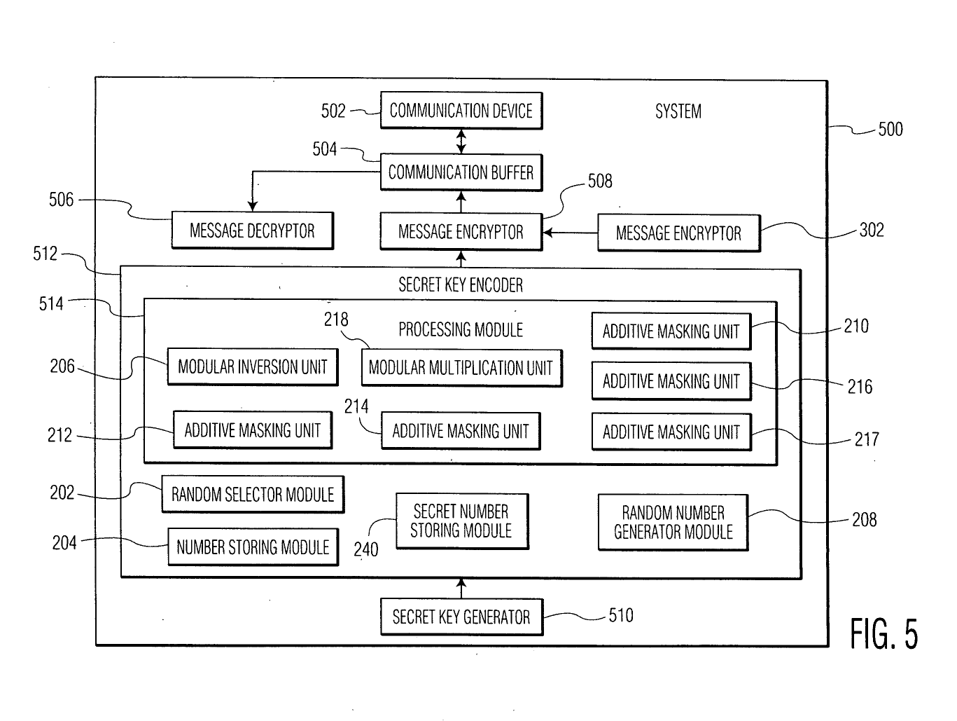

FIG. 5 is a schematic block diagram of an embodiment of a system for encoding a secret key into an encoded secret key and encrypting a message using the encoded secret key.

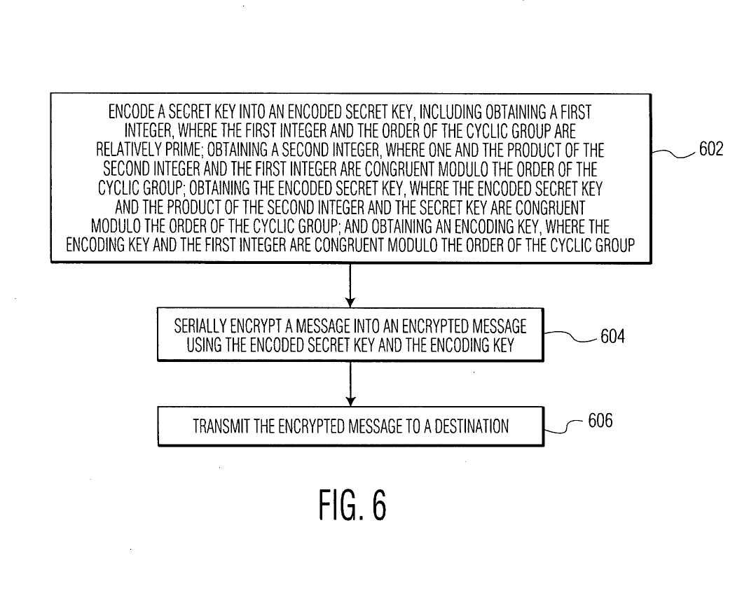

FIG. 6 is a process flow diagram of a method for performing data encryption for a cryptographic system that utilizes a cyclic group having an order.

Throughout the description, similar reference numbers may be used to identify similar elements.

FIG. 1 illustrates communications between a cryptographic system 100 and a destination 102 via a communications network 104. The cryptographic system encrypts messages into encrypted messages using the systems that are disclosed herein and transmits the encrypted messages to the destination through the communications network. The destination receives the encrypted messages and sends responses to the cryptographic system through the communications network.

In some embodiments, the cryptographic system 100 encodes a secret key into an encoded secret key and an encoding key and uses the encoded secret key and the encoding key to perform encryption on messages to generate encrypted messages (not shown) using the systems that are disclosed herein and transmits the encrypted messages to the destination 102 through the communications network 104. The term encryption can refer to any cryptographic operation involving a private key, for example, digitally signing a message, decrypting an encrypted message, calculating a public key from a secret key in a Diffie-Hellman protocol, and calculating a shared secret from a public key in a Diffie-Hellman protocol. The term encryption can also refer to any cryptographic operation involving a public key, for example, verifying the digital signature of a message and encrypting a message.

Various systems for encrypting a message are described below with reference to FIGS. 2a-2c, FIGS. 3a-3b, and FIG. 4. In particular, FIGS. 2a-2c depict three embodiments of a system for encoding a secret key, FIGS. 3a-3b depict two embodiments of a system for encrypting a message using an encoded secret key and an encoding key, and FIG. 4 illustrates an embodiment of a system for repeatedly encrypting a message using an encoded secret key and one or more encoding keys that are generated using the systems for encoding a secret key that are depicted in FIGS. 2a-2c.

FIG. 2a depicts an embodiment of a system 200 for encoding a secret key, sk, which can be implemented within the cryptographic system 100 of FIG. 1. The system includes a random selector module 202, a number storing module 204, a modular inversion unit 206, a random number generator module 208, five additive masking units 210, 212, 214, 216, and 217, and a modular multiplication unit 218. In the embodiment described with reference to FIG. 2a, the random selector module randomly chooses a first integer, n₁, from a set of integers stored in the number storing module, which is different from zero and relatively prime to the order of a cyclic group, ø.

In some embodiments, the set of integers may be chosen so that the message encryption can be implemented by a small number of operations. In some embodiments, the length of the first integer, n₁, may be chosen such that an optimal trade-off between security and performance is obtained. For example, the first integer, n₁, may include more than or equal to thirty-two bits and less than or equal to sixty-four bits.

In the embodiment described with reference to FIG. 2a, the additive masking unit 217 receives the first integer, n₁, from the random selector module 202 and performs masking on the first integer, n₁, to produce a masked first integer, n₁′. For example, the additive masking unit may receive the order of the cyclic group, ø, and an integer from the random number generator module that is greater than zero and calculate the sum of the first integer, n₁, and the product of the integer and the order of the cyclic group, ø, as the masked first integer, n₁′. In some embodiments, there may be no additive masking unit that performs masking on the first integer, where the first integer, n₁, is input directly into the modular inversion unit 206.

The modular inversion unit 206 receives the masked first integer, n₁′, from the additive masking unit 217, the order of the cyclic group, ø, and a third integer, n₃, which is generated by the random number generator module 208 and which is different from zero and relatively prime to the masked first integer, n₁′. The modular inversion unit generates a second integer, n₂, which is smaller than the product of the third integer, n₃, and the order of the cyclic group, ø, such that one and the product of the second integer, n₂, and the masked first integer, n₁′, are congruent modulo the product of the third integer, n₃, and the order of the cyclic group, ø. This operation can be expressed as:

n₂=(n₁′)⁻¹ mod (n₃×φ) (1)

The second integer, n₂, is the modular inverse of the masked first integer, n₁′, modulo the product of the third integer, n₃, and the order of the cyclic group, ø, where the modular inverse of an integer I₁ modulo an integer N is an integer I₂ such that one and the product of I₁ and I₂ is congruent modulo N and I₂ is smaller than N and greater than zero. For example, the modular inverse can be expressed as:

I₂=I₁⁻¹(mod N) [symbol] I₁×I₂=1(mod N), 0<2<N (2)

In some embodiments, the third integer, n₃, is set to one.

The additive masking unit 210 receives the first integer, n₁, from the random selector module 202 and performs masking on the first integer, n₁, to produce an encoding key. For example, the additive masking unit may receive the order of the cyclic group, ø, and an integer from the random number generator module that is greater than zero and calculate the sum of the first integer, n₁, and the product of the integer and the order of the cyclic group, ø, as the encoding key. In some embodiments, there may be no additive masking unit that performs masking on the first integer, where the encoding key is the first integer, n₁.

The additive masking unit 212 receives the second integer, n₂, and performs masking on the second integer, n₂, to produce a masked second integer, n₂′. As shown in FIG. 2a, the additive masking unit receives a fourth integer, n₄, generated by the random number generator module 208 and produces the masked second integer, n₂′, which is equal to the sum of the second integer, n₂, and the product of the fourth integer, n₄, and the order of the cyclic group, ø. This operation can be expressed as:

n₂′=n₂+n₄×φ (3)

In some embodiments, there may be no additive masking unit that performs masking on the second integer, n₂, where the second integer, n₂, is directly input into the modular multiplication unit 218.

The additive masking unit 214 receives a secret key, sk, and performs masking on the secret key, sk, to produce a masked secret key, sk′. As shown in FIG. 2a, the additive masking unit receives a seventh integer, n₇, generated by the random number generator module 208 and produces the masked secret key, sk′, which is equal to the sum of the secret key, sk, and the product of the seventh integer, n₇, and the order of the cyclic group, ø. This operation can be expressed as:

sk′=sk+n₇×φ (4)

In some embodiments, there may be no additive masking unit that performs masking on the secret key, sk, where the secret key, sk, is directly input into the modular multiplication unit 218.

The modular multiplication unit 218 receives the masked second integer, n₂′, the masked secret key, sk′, a sixth integer, n₆, which is greater than zero and generated by the random number generator module 208, and the order of the cyclic group, ø. The modular multiplication unit generates an encoded secret key, esk, which is equal to the product of the masked second integer, n₂′, and the masked secret key, sk′, modulo the product of the sixth integer, n₆, and the order of the cyclic group, ø. This operation can be expressed as:

esk=(n₂′×sk′)mod(n₆×φ) (5)

In some embodiments, the sixth integer, n₆, is set to one.

The additive masking unit 216 performs masking on the encoded secret key, esk. As shown in FIG. 2a, the additive masking unit generates a masked encoded secret key, esk′, which is equal to the sum of the product of a fifth integer, n₅, which is generated by the random number generator module 208, and the order of the cyclic group, ø, and the encoded secret key, esk, from the modular multiplication unit 218. This operation can be expressed as:

esk′=esk+(n₅×φ) (6)

In some embodiments, there may be no additive masking unit that performs masking on the encoded secret key, esk, where the encoded secret key, esk, is directly input into a system for encrypting a message using an encoded secret key and an encoding key as depicted in FIG. 3a.

FIG. 3a depicts an embodiment of a system 300 for encrypting a message using an encoded secret key and an encoding key, which can be implemented within the cryptographic system 100 of FIG. 1. The system includes a message generator 302 and two encryption units 304 and 306. In the embodiment described with reference to FIG. 3a, the message generator generates messages. The message generator may be implemented in software, hardware, or a combination of software and hardware. The encryption unit 304 receives the messages from the message generator and the encoding key from the additive masking unit 210 of FIG. 2a and encrypts the messages using the encoding key. The encryption unit 306 receives the masked encoded secret key, esk′, from the additive masking unit 216 of FIG. 2a and the encryption result from the encryption unit 304 and encrypts the encryption result from the encryption unit 304 using the masked encoded secret key, esk′, to produce encrypted messages.

The system 200 depicted in FIG. 2a and the system 300 depicted in FIG. 3a perform encoding operations that use random encoding keys to encode secret keys into encoded secret keys and perform encryption operations with encoded secret keys and random encoding keys to encrypt messages that are equivalent to performing encryption operations using the secret key to encrypt messages. As a result, the system depicted in FIG. 2a and the system depicted in FIG. 3a improve the security of the cryptographic system 100 against side channel analysis with a low overhead. The system depicted in FIG. 2a and the system depicted in FIG. 3a can be combined with other systems that randomize the encryption operations.

FIG. 2b depicts another embodiment of a system 230 for encoding a secret key, sk, which can be implemented within the cryptographic system 100 of FIG. 1. The system includes a modular inversion unit 206, a random number generator module 208, five additive masking units 210, 212, 214, 216, and 217, and a modular multiplication unit 218. The difference between the system 230 described with reference to FIG. 2b and the system 200 described with reference to FIG. 2a is that in the system described with reference to FIG. 2b the first integer, n₁, is randomly generated by the random number generator module and in the system described with reference to FIG. 2a the first integer, n₁, is randomly chosen by the random selector module 202 from the set of integers stored in the number storing module 204. Randomly selecting the first integer, n₁, in the system described with reference to FIG. 2a involves the random selector module and the number storing module. Randomly generating the first integer, n₁, in the system described with reference to FIG. 2b involves only the random number generator module, which is also used to generate other parameters for the system. The other operations for encoding secret keys in the system described with reference to FIG. 2b are the same as the corresponding operations for encoding secret keys in the system described with reference to FIG. 2a. In some embodiments, the length of the first integer, n₁, may be chosen such that an optimal trade-off between security and performance is obtained. For example, the first integer, n₁, may include more than or equal to thirty two bits and less than or equal to sixty four bits.

FIG. 3b depicts another embodiment of a system 330 for encrypting a message using an encoded secret key and an encoding key, which can be implemented within the cryptographic system 100 of FIG. 1. The system includes a message generator 302 and two encryption units 304 and 306. In the embodiment described with reference to FIG. 3b, the message generator generates messages. The encryption unit 304 receives the messages from the message generator and the masked encoded secret key, esk′, from the additive masking unit 216 of FIG. 2b and encrypts the messages using the masked encoded secret key, esk′. The encryption unit 306 receives the encryption result from the encryption unit 304 and the encoding key from the additive masking unit 210 of FIG. 2b and encrypts the encryption result from the encryption unit 304 using the encoding key.

FIG. 2c depicts another embodiment of a system 260 for encoding a secret key, sk, which can be implemented within the cryptographic system 100 of FIG. 1. The system includes a secret number storing module 240, a random number generator module 208, four additive masking units, 210, 212, 214, and 216, and a modular multiplication unit 218. The difference between the system 260 described with reference to FIG. 2c and the system 200 described with reference to FIG. 2a is that in the system described with reference to FIG. 2c the first integer, n₁, and the second integer, n₂, are obtained from the secret number storing module and in the system described with reference to FIG. 2a the first integer, n₁, is randomly chosen by the random selector module from the set of integers stored in the secret number storing module and the second integer, n₂, is calculated based on the first integer, n₁. In the system described with reference to FIG. 2c, pairs of the first integer, n₁, and the second integer, n₂ are pre-calculated. Compared to the system described with reference to FIG. 2a, the system described with reference to FIG. 2c has a lower computation overhead. The other operations for encoding secret keys in the system described with reference to FIG. 2c are the same as the corresponding operations for encoding secret keys in the system described with reference to FIG. 2a. In some embodiments, the length of the first integer, n₁, may be chosen such that an optimal trade-off between security and performance is obtained. For example, the first integer, n₁, may include more than or equal to thirty two bits and less than or equal to sixty four bits.

FIG. 4 illustrates an embodiment of a system 400 for repeatedly encrypting a message using an encoded secret key and one or more encoding keys that are generated using the systems for encoding a secret key that are depicted in FIGS. 2a-2c. The system shown in FIG. 4 can be used to improve the security of the secret keys for the cryptographic systems. Compared to the system 300 depicted in FIG. 3a and the system 330 depicted in FIG. 3b, the system illustrated in FIG. 4 improves the protection against side channel analysis of the cryptographic systems. The system includes a message generator 302, four encryption units 404, 406, 408, and 410, and three systems for encoding a secret key that are depicted in FIGS. 2a-2c.

In the embodiment described with reference to FIG. 4, the message generator 302 generates messages. The encryption unit 404 receives the messages from the message generator and a first encoding key, which is generated using the systems that are depicted in FIGS. 2a-2c, and encrypts the messages using the first encoding key. The encryption unit 406 receives an encrypted result from the encryption unit 404 and a second encoding key, which is generated using the systems that are depicted in FIGS. 2a-2c, and encrypts the encryption result from the encryption unit 404 using the second encoding key. The encryption unit 408 receives an encrypted result from the encryption unit 406 and a third encoding key, which is generated using the systems that are depicted in FIGS. 2a-2c, and encrypts the encryption result from the encryption unit 406 using the third encoding key. The encryption unit 410 receives an encrypted result from the encryption unit 408 and an encoded secret key, which is generated using the systems that are depicted in FIGS. 2a-2c, and encrypts the encryption result from the encryption unit 408 using the encoded secret key. In some embodiments, message encryption using the encoding key is performed after message encryption using the encoded secret key. Although encryption of the messages is performed four times in FIG. 4, the encryption may be performed less than four times or more than four times. In some embodiments, the number of times that a message is encrypted may be adjusted to achieve a predefined performance factor.

FIG. 5 is a schematic block diagram of an embodiment of a system 500 for encoding a secret key into an encoded secret key and encrypting a message using the encoded secret key, which can be implemented within the cryptographic system 100 of FIG. 1. The system includes a communication device 502 to communicate with the destination (not shown), a communication buffer 504, a message decryptor 506 to decrypt messages from the destination, a message generator 302 to generate messages, a message encryptor 508 to encrypt the messages, a secret key generator 510 to generate the secret key, and a secret key encoder 512 to encode the secret key. Although the system depicted in FIG. 5 includes several functional blocks described herein, other embodiments may include fewer or more functional blocks to implement more or less functionality.

In some embodiments, the system 500 utilizes a cyclic group to represent the encrypted messages. In some embodiments, the system is integrated in a Rivest, Shamir, and Adleman (RSA) cryptographic system. In some embodiments, the system is integrated in an elliptic curve cryptography (ECC) cryptographic system. In some embodiments, the system is integrated in a hyperelliptic curve cryptography (HECC) cryptographic system.

The communication device 502 includes at least one transmitter (not shown) to transmit encrypted messages to the destination and at least one receiver (not shown) to receive response information from the destination. The communication device may implement wired or wireless communication technology. The communication buffer 504 may be separated into two buffers, for example, a transmission buffer (not shown) and a reception buffer (not shown). The communication buffer may be implemented in hardware, such as RAM, or software, or a combination of hardware and software.

The message generator 302 generates messages and the message encryptor 508 encrypts the messages generated by the message generator into encrypted messages. The message encryptor may serially encrypt messages generated by the message generator into encrypted messages using an encoded secret key from the secret key encoder 512 and an encoding key, where the encoded secret key is generated from the secret key and the encoding key. In some embodiments, for example, when the system 500 is integrated in a RSA cryptographic system, the message encryptor may serially perform exponentiation operations on messages generated by the message generator with the encoded secret key and the encoding key. In some embodiments, for example, when the system is integrated in an ECC cryptographic system or a HECC cryptographic system, the message encryptor may serially multiply messages generated by the message generator using the encoded secret key and the encoding key. The secret key generator 510 generates a secret key and the secret key encoder 512 encodes the secret key. In the embodiment described with reference to FIG. 5, the secret key encoder includes a number storing module 204 to store a number of encoding keys, a random selector module 202 to select encoding keys from the number storing module, a secret number storing module 240 to store a number of secret sets of encoding keys, a random number generator module 208 to randomly generate encoding keys, and a processing module 514 to process the secret keys and the encoding keys and to produce the encoded secret keys. In some embodiments, the secret key encoder may not include the number storing module and the random selector module. In some embodiments, the secret key encoder may not include the secret number storing module.

The processing module 514 includes a modular inversion unit 206 to perform modular inversion operations, a modular multiplication unit 218 to perform nodular multiplication operations, and five additive masking units 210, 212, 214, 216, and 217, to perform masking operations. In some embodiments, the processing module may not include the modular inversion unit. In some embodiments, the processing module may not include the additive masking unit. Although the processing module includes five additive masking units in FIG. 5, the processing module may include fewer than five additive masking units or more than five additive masking units.

FIG. 6 is a process flow diagram of a method for performing data encryption for a cryptographic system that utilizes a cyclic group having an order. At block 602, a secret key is encoded into an encoded secret key, where a first integer is obtained, where the first integer and the order of the cyclic group are relatively prime, a second integer is obtained, where one and the product of the second integer and the first integer are congruent modulo the order of the cyclic group, the encoded secret key is obtained, where the encoded secret key and the product of the second integer and the secret key are congruent modulo the order of the cyclic group, and the encoding key is obtained, where the encoding key and the first integer are congruent modulo the order of the cyclic group. At block 604, a message is serially encrypted into an encrypted message using the encoded secret key and the encoding key. At block 606, the encrypted message is transmitted to a destination.

Although the operations of the method herein are shown and described in a particular order, the order of the operations of the method may be altered so that certain operations may be performed in an inverse order or so that certain operations may be performed, at least in part, concurrently with other operations. In another embodiment, instructions or sub-operations of distinct operations may be implemented in an intermittent and/or alternating manner.

Embodiments of the system and method for encrypting data based on cyclic groups can be applied to RSA cryptographic systems, ECC cryptographic systems, and HECC cryptographic systems. Embodiments of the system and method for encrypting data based on cyclic groups can also be applied to any cryptographic systems that utilize cyclic groups to encrypt data.

Although specific embodiments of the invention have been described and illustrated, the invention is not to be limited to the specific forms or arrangements of parts so described and illustrated. The scope of the invention is to be defined by the claims appended hereto and their equivalents.

What is claimed is:

1. A method of performing data encryption for a cryptographic system that utilizes a cyclic group having an order, the method comprising:
encoding a secret key into an encoded secret key using an encoding key, wherein the secret key and the product of the encoded secret key and the encoding key are congruent modulo the order of the cyclic group;
serially encrypting a message into an encrypted message using the encoded secret key and the encoding key; and
transmitting the encrypted message to a destination.

2. The method of claim 1, wherein the encoding key and the order of the cyclic group are relatively prime.

3. The method of claim 1, wherein the encoding key is randomly chosen from a set of encoding keys.

4. The method of claim 1, wherein the encoding key is randomly generated.

5. The method of claim 1, wherein the encoding key is chosen from a previously calculated and stored secret set of integers.

6. The method of claim 1, wherein encoding the secret key into the encoded secret key using the encoding key is performed a plurality of times and serially encrypting the message is performed a corresponding plurality of time.

7. A method of performing data encryption for a cryptographic system that utilizes a cyclic group having an order, the method comprising:
encoding a secret key into an encoded secret key, wherein encoding the secret key includes:
obtaining a first integer, wherein the first integer and the order of the cyclic group are relatively prime;
obtaining a second integer, wherein one and the product of the second integer and the first integer are congruent modulo the order of the cyclic group;
obtaining the encoded secret key, wherein the encoded secret key and the product of the second integer and the secret key are congruent modulo the order of the cyclic group; and
obtaining an encoding key, wherein the encoding key and the first integer are congruent modulo the order of the cyclic group;
serially encrypting a message into an encrypted message using the encoded secret key and the encoding key; and
transmitting the encrypted message to a destination.

8. The method of claim 7, wherein the second integer is obtained as a modular inverse of a function of the first integer modulo the product of a third integer and the order of the cyclic group, wherein the function of the first integer and the third integer are relatively prime.

9. The method of claim 8, wherein the function of the first integer is the sum of the first integer and the product of a fourth integer and the order of the cyclic group.

10. The method of claim 7, wherein the encoded secret key is obtained as the sum of the product of a function of the second integer and the secret key and the product of a fifth integer and the order of the group modulo the product of a sixth integer and the order of the cyclic group, wherein the fifth integer is smaller than the sixth integer.

11. The method of claim 7, wherein obtaining the first integer includes randomly choosing the first integer from a set of integers.

12. The method of claim 7, wherein obtaining the first integer includes randomly generating the first integer.

13. The method of claim 7, wherein obtaining the first integer and obtaining the second integer includes choosing the first integer and the second integer from a secret set of integers, wherein the secret set of integers is previously calculated and stored.

14. The method of claim 7, wherein encoding the secret key is performed a plurality of times and serially encrypting the message is performed a corresponding plurality of times.

15. A system for performing data encryption that utilizes a cyclic group having an order, the system comprising:
a secret key generator configured to generate a secret key;
a secret key encoder configured to encode the secret key into an encoded secret key using an encoding key, wherein the secret key and the product of the encoded secret key and the encoding key are congruent modulo the order of the cyclic group;
a message generator configured to generate a message;
a message encryptor configured to serially encrypt the message from the message generator into an encrypted message using the encoded secret key and the encoding key; and
a communication device configured to transmit the encrypted message to a destination.

16. The system of claim 15, wherein the secret key encoder includes a random number generator module and a processing module, wherein the processing module includes a modular inversion unit configured to perform modular inversion operations and a modular multiplication unit configured to perform modular multiplication operations.

17. The system of claim 16, wherein the processing module includes at least one additive masking unit configured to perform masking operations.

18. The system of claim 15, wherein the secret key encoder includes a secret number storing module configured to store a number of secret sets of integers and a processing module, wherein the processing module includes a modular inversion unit configured to perform modular inversion operations and a modular multiplication unit configured to perform modular multiplication operations.

19. The system of claim 15, wherein the secret key encoder includes a number storing module configured to store a number of encoding keys, a random selector module configured to select an encoding key from the number storing module, and a processing module, wherein the processing module includes a modular inversion unit configured to perform modular inversion operations and a modular multiplication unit configured to perform modular multiplication operations.

20. The system of claim 15, wherein the system is integrated in a Rivest, Shamir, and Adleman cryptographic system, or an elliptic curve cryptography cryptographic system, or a hyperelliptic curve cryptography cryptographic system.
